(19) United States
(12) Patent Application Publication
(10) Pub. No.: US 2021/0405851 A1
(43) Pub. Date: Dec. 30, 2021

(54) VISUAL INTERFACE FOR A COMPUTER SYSTEM

(71) Applicant: Microsoft Technology Licensing, LLC, Redmond, WA (US)

(72) Inventors: Chihua WU, Tokyo (JP); Yuki UENO, Tokyo (JP)

(21) Appl. No.: 17/012,014

(22) Filed: Sep. 3, 2020

(30) Foreign Application Priority Data
Jun. 29, 2020 (GB) 2009876.0

(51) Int. Cl. G06F 3/0481; G06F 3/0482; G06F 3/01; G06F 9/451

(52) U.S. Cl. CPC G06F 3/04815; G06F 9/451; G06F 3/011; G06F 3/0482

(57) ABSTRACT

Tracking inputs are processed to facilitate user engagement with a visual interface having selectable visual elements. In response to the tracking inputs satisfying an engagement condition of any of the visual elements, a selection routine for the visual element is instigated based on a selection parameter of the visual element. If the engagement condition remains satisfied until a selection criterion is met, an associated action is instigated. If the engagement condition stops being satisfied before the selection criterion is met, the selection routine terminates without selecting the visual element. Each time any of the visual elements is selected, a predictive model is used to update the selection parameter of at least one other of the visual elements, thereby modifying a duration for which the engagement condition must be satisfied before the selection criterion is met according to a likelihood of the other visual element being subsequently selected.

### CROSS-REFERENCE TO RELATED APPLICATION

This application claims priority to GB Patent Application No. 2009876.0, entitled “Visual Interface for a Computer System,” filed on Jun. 29, 2020, the disclosure of which is incorporated herein by reference in its entirety.

### TECHNICAL FIELD

The present disclosure pertains to a visual interface for a computer system, and to methods and computer programs to facilitate user engagement with the same.

### BACKGROUND

An effective user interface (UI) allows a user to engage intuitively and seamlessly with a computer. A well configured UI may allow a user to provide inputs quickly and with reduced scope for errors, and provide intuitive feedback to the user. A graphical user interface (GUI) is a form of visual interface that can receive user input and display feedback in visual form. Visual interfaces can be implemented in a variety of computing environments, such as traditional laptop/desktop computers; smartphones, tablets and other touchscreen devices; and newer forms of user device like augmented reality (AR) or virtual reality (VR) headsets, “smart” glasses and the like. The terms AR and mixed reality (MR) are used interchangeably herein.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

The present disclosure pertains to a novel form of visual interface having both efficiency and accuracy benefits. Efficiency refers to the amount of time taken for a user to provide a desired sequence of selections. Accuracy refers to the susceptibility of the interface to unintended selections.

A first aspect herein provides a computer-implemented method of processing tracking inputs for engaging with a visual interface having selectable visual elements. The tracking inputs are received for tracking user motion. The tracking inputs are processed and, in response to the tracking inputs satisfying an engagement condition of any of the visual elements, a selection routine for the visual element is instigated based on at least one selection parameter of the visual element. If the engagement condition remains satisfied until a selection criterion of the selection routine is met, an action associated with the visual element is instigated (that is, the visual element is selected). If the engagement condition stops being satisfied before the selection criterion is met, the selection routine terminates without selecting the visual element (without triggering the associated action). Each time any of the visual elements is selected, a predictive model is used to update the at least one selection parameter of at least one other of the visual elements, thereby modifying a duration for which the engagement condition must be satisfied before the selection criterion is met (selection duration) according to a likelihood of the other visual element being subsequently selected.

With the present visual interface, a user can select a desired element by maintaining the engagement condition for the required duration. That duration is not fixed, but is varied according to the likelihood of the user selecting that element, based on his or her previous selection(s). If the model predicts a relatively high likelihood of the user selecting a particular element, this reduces the amount of time for which the engagement condition must be maintained in order to select it; thus, the it takes less time for the user to select that element. Conversely, if the model predicts a relatively low likelihood of a particular element being selected, the engagement condition must be maintained for a longer duration in order to actually select that element; this makes it harder for the user to inadvertently select that element, because if they inadvertently trigger its engagement condition, they have more time before the key is selected to rectify that mistake. The predictions by the predictive model need only be reasonably well correlated with the user's actual selections for this to provide overall improvements in accuracy and efficiency over a number of selections. Once a user has selected a particular one of the visual elements, the respective selection parameters of two or more of the visual elements may be updated such that those visual elements have different selection durations reflecting their different respective likelihoods of being selected next.

One example application of the visual interface is in a 3D augmented or virtual reality environment. In this context, the visual interface may be a virtual 3D object with which a user can engage in 3D space. For example, the engagement condition for a given element may be satisfied for as long as a pose vector of the user interests that element (the user is said to be pointing at the element in that event). This could, for example, be a head or eye pose (such that the user engages with a given element by pointing their head or gaze towards it), which has the benefit that no hand tracking, gesture detection, or hand-held controller is required. However, the techniques can also be applied based on e.g. a tracked a limb or digit pose (such that the user engages with a given element by pointing e.g. their arm or finger towards it). In whatever manner the tracking is implemented, in order to select a given element, the user would keep pointing at it for the required duration it until the selection condition is met. The amount of time for which they would be required to keep pointing at it is not fixed and would depend the estimated likelihood of them actually selecting it, and would be reduced for elements the user is more likely to select.

### BRIEF DESCRIPTION OF FIGURES

For a better understanding of the present disclosure, and to show how embodiments of the same may be carried into effect, reference is made by way of example only to the following figures in which:

FIGS. 1A and 1B show, respectively, a schematic perspective view and schematic block diagram of a MR headset;

FIG. 2 shows a schematic function block diagram of a user interface layer;

FIG. 3 shows a schematic perspective view of a gravity key interface rendered in a 3D augmented or mixed reality environment; and

FIG. 4 shows a flowchart for a method of processing tracking inputs for engaging with a visual interface.

### DETAILED DESCRIPTION

With the prevalence of smartphones, tablets and other modern touchscreen devices, much attention has been given to improved touchscreen interfaces. However, newer types of user device, such as virtual or augmented reality headsets, “smart” glasses etc., present new challenges. For instance, in a 3D virtual or augmented reality context, there are various challenges in designing effective key-selection interfaces and the like, that can be usefully deployed in a “virtual” 3D world, and which can match more traditional forms of interface in terms of efficiency (time taken to make a sequence of desired key selections), accuracy (reducing instances of unintended key selections) and/or intuitiveness. When it comes to intuitive feedback, one particular challenge in certain virtual contexts may be the lack of tactile feedback compared with physical or touchscreen keyboards and the like.

Existing text entry mechanisms on headset-based devices typically require either hand recognition or a connected controller. For example, in some MR systems, a virtual static keyboard surface is presented to user. The user moves the headset to point to the key and commits (selects) the key using a hand-held controller (clicker) or finger gesture. In other systems, the user uses a hand-held controller to point to the key and the user similarly commits the key by pressing a button on the controller. These modalities are a direct mirror of established 2D interfaces, but are generally not optimized for an interactive 3D environment through which a user can move and with which he or she can interact.

By contrast, herein, a novel form of 3D visual interface utilises a depth dimension (z) to provide a key-level dynamic interface with optimized input speed and accuracy. This may be referred to as a “gravity key” interface herein.

The gravity key interface is highly suitable for rendering in a 3D mixed or virtual reality environment. In this context, the gravity key interface is implemented as a virtual 3D object, that may be rendered along with other virtual 3D structure, with which a user can engage in 3D space.

The gravity interface has multiple selectable elements (keys), which a user point to for a certain duration in order to select that key and thus trigger an associated action (such as providing a corresponding character selection input to an application).

In the described examples, the required duration is defined by an initial depth of the key relative to a location of the user. A motion model (e.g. constant acceleration) is used to incrementally decrease the depth of the key relative to the user, for as long as the user keeps pointing at the key. When a threshold depth is reached, the key is selected, triggering the associated action. The greater the initial depth, the longer the user must keep pointing at it in order reach the threshold depth and thus select the key.

Moreover, in 3D space, when an object is presented closer to user, the object become clearer and larger, i.e. it occupies a larger visible area. This further reduces the time required to search for a key (because the user has a larger visible area to point to), and also assists with accuracy (the user is less likely to inadvertently point to a less likely and more distant key that occupies a smaller visible area).

That is, the depth of a key not only determines how long a user must point to a key in order to select it (its selection duration, which is reduced for more likely keys, by reducing the depth of the key relative to the user), but also determines the visible area of the key to which the user must point (increased by reducing the depth of the key relative to the user).

The x and y position of each key is fixed within the environment. However, the z position (depth) is predicted each time a key selection is made. This means that keys that are more likely to be selected next are rendered closer to the user in the z-direction than keys that are less likely to be selected less. The selection duration is shorter for keys closer to the user (because they have less far to travel to reach the depth threshold required for selection), and their visible area is larger.

The described interface can be implemented based on head or gaze tracking, and such implementations require no hand recognition or connected controller for text entry.

Further example implementation details are described below. First, some useful context is described.

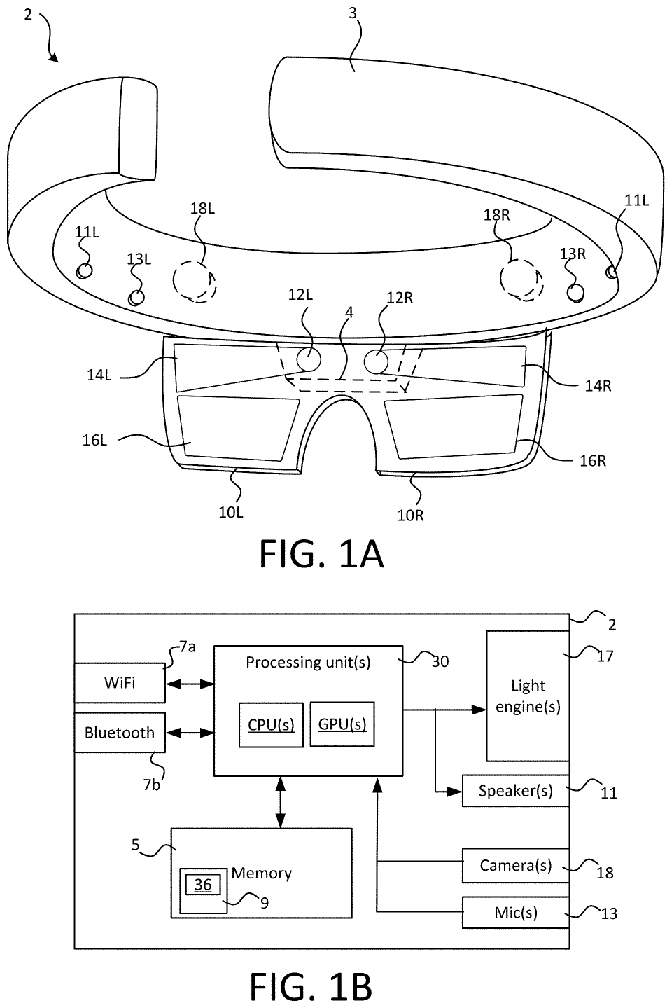

FIG. 1A shows a perspective view of a wearable augmented reality (“AR”) device 2, from the perspective of a wearer of the device 2 (“AR user”). FIG. 1B shows a schematic block diagram of the AR device 2. The AR device 2 is a computer device in the form of a wearable headset. FIGS. 1A and 1B are described in conjunction.

The augmented reality device 2 comprises a headpiece 6, which is a headband, arranged to be worn on the wearer's head. The headpiece 6 has a central portion 4 intended to fit over the nose bridge of a wearer, and has an inner curvature intended to wrap around the wearer's head above their ears.

The headpiece 3 supports left and right optical components, labelled 10L and 10R, which are waveguides. For ease of reference herein an optical component 10 will be considered to be either a left or right component, because the components are essentially identical apart from being mirror images of each other. Therefore, all description pertaining to the left-hand component also pertains to the right-hand component. The central portion 4 houses at least one light engine 17 which is not shown in FIG. 1A but which is depicted in FIG. 1B.

The light engine 17 comprises a micro display and imaging optics in the form of a collimating lens (not shown). The micro display can be any type of image source, such as liquid crystal on silicon (LCOS) displays, transmissive liquid crystal displays (LCD), matrix arrays of LED's (whether organic or inorganic) and any other suitable display. The display is driven by circuitry which is not visible in FIGS. 1A and 1B which activates individual pixels of the display to generate an image. Substantially collimated light, from each pixel, falls on an exit pupil of the light engine 4. At the exit pupil, the collimated light beams are coupled into each optical component, 10L, 10R into a respective in-coupling zone 12L, 12R provided on each component. These in-coupling zones are clearly shown in FIG. 1A. In-coupled light is then guided, through a mechanism that involves diffraction and TIR, laterally of the optical component in a respective intermediate (fold) zone 14L, 14R, and also downward into a respective exit zone 16L, 16R where it exits the component 10 towards the users' eye. Each optical component 10L, 10R is located between the light engine 13 and one of the user's eye i.e. the display system configuration is of so-called transmissive type.

The collimating lens collimates the image into a plurality of beams, which form a virtual version of the displayed image, the virtual version being a virtual image at infinity in the optics sense. The light exits as a plurality of beams, corresponding to the input beams and forming substantially the same virtual image, which the lens of the eye projects onto the retina to form a real image visible to the AR user. In this manner, the optical component 10 projects the displayed image onto the wearer's eye. The optical components 10L, 10R and light engine 17 constitute display apparatus of the AR device 2.

The zones 12L/R, 14L/R, 16L/R can, for example, be suitably arranged diffractions gratings or holograms. The optical component 10 has a refractive index n which is such that total internal reflection takes place to guide the beam from the light engine along the intermediate expansion zone 314, and down towards the exit zone 16L/R.

The optical component 10 is substantially transparent, whereby the wearer can see through it to view a real-world environment in which they are located simultaneously with the projected image, thereby providing an augmented reality experience.

To provide a stereoscopic image, i.e. that is perceived as having 3D structure by the user, slightly different versions of a 2D image can be projected onto each eye—for example from different light engines 17 (i.e. two micro displays) in the central portion 4, or from the same light engine (i.e. one micro display) using suitable optics to split the light output from the single display.

The wearable AR device 2 shown in FIG. 1A is just one exemplary configuration. For instance, where two light-engines are used, these may instead be at separate locations to the right and left of the device (near the wearer's ears). Moreover, whilst in this example, the input beams that form the virtual image are generated by collimating light from the display, an alternative light engine based on so-called scanning can replicate this effect with a single beam, the orientation of which is fast modulated whilst simultaneously modulating its intensity and/or colour. A virtual image can be simulated in this manner that is equivalent to a virtual image that would be created by collimating light of a (real) image on a display with collimating optics. Alternatively, a similar AR experience can be provided by embedding substantially transparent pixels in a glass or polymer plate in front of the wearer's eyes, having a similar configuration to the optical components 10A, 10L though without the need for the zone structures 12, 14, 16. As will be appreciated, there are numerous ways to implement an MR or VR system of the general kind depicted in FIG. 1, using a variety of optical component.

Other headpieces 6 are also viable. For instance, the display optics can equally be attached to the user's head using a frame (in the manner of conventional spectacles), helmet or other fit system. The purpose of the fit system is to support the display and provide stability to the display and other head borne systems such as tracking systems and cameras. The fit system can be designed to meet user population in anthropometric range and head morphology and provide comfortable support of the display system.

The AR device 2 also comprises one or more cameras 18—stereo cameras 18L, 18R mounted on the headpiece 3 and configured to capture an approximate view (“field of view”) from the user's left and right eyes respectfully in this example. The cameras 18L, 18R are located towards either side of the user's head on the headpiece 3, and thus capture images of the scene forward of the device form slightly different perspectives. In combination, the stereo camera's capture a stereoscopic moving image of the real-world environment as the device moves through it. A stereoscopic moving image means two moving images showing slightly different perspectives of the same scene, each formed of a temporal sequence of frames to be played out in quick succession to replicate movement. When combined, the two images give the impression of moving 3D structure.

As shown in FIG. 1B, the AR device 2 also comprises: one or more loudspeakers 11; one or more microphones 13; memory 5; processing apparatus in the form of one or more processing units 30 (e.g. CPU(s), GPU(s), and/or bespoke processing units optimized for a particular function, such as AR related functions); and one or more computer interfaces for communication with other computer devices, such as a Wi-Fi interface 7a, Bluetooth interface 7b etc. The wearable device 30 may comprise other components that are not shown, such as dedicated depth sensors, additional interfaces etc.

As shown in FIG. 1A, a left microphone 11L and a right microphone 13R are located at the front of the headpiece (from the perspective of the wearer), and left and right channel speakers, earpiece or other audio output transducers are to the left and right of the headband 3. These are in the form of a pair of bone conduction audio transducers 111, 11R functioning as left and right audio channel output speakers.

Though not evident in FIG. 1A, the processing apparatus 3, memory 5 and interfaces 7a, 7b are housed in the headband 3. Alternatively, these may be housed in a separate housing connected to the components of the headband 3 by wired and/or wireless means. For example, the separate housing may be designed to be worn or a belt or to fit in the wearer's pocket, or one or more of these components may be housed in a separate computer device (smartphone, tablet, laptop or desktop computer etc.) which communicates wirelessly with the display and camera apparatus in the AR headset 2, whereby the headset and separate device constitute an augmented reality apparatus.

It will also be appreciated that MR application are not limited to headsets. For example, modern tablets, smartphones and the like are often equipped to provide MR experiences. In this context, the described visual interface could, for example, be implemented based on gaze tracking or, in the case of a handheld device, device motion tracking (where the user would move the device to select keys).

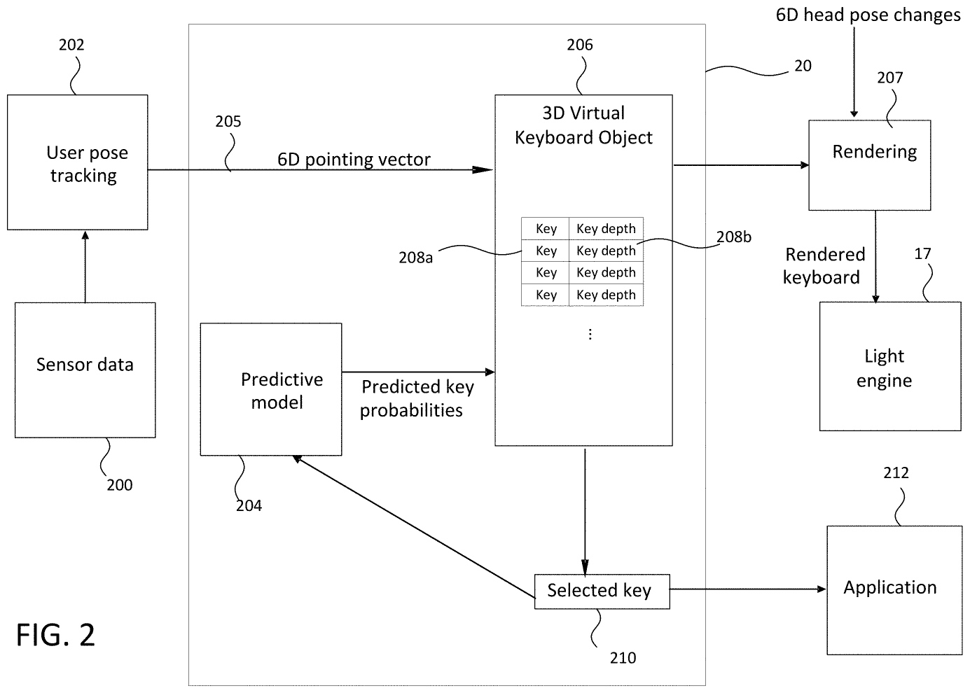

The memory holds executable code 9 that the processor apparatus 3 is configured to execute. In some cases, different parts of the code 9 may be executed by different processing units of the processing apparatus 3. The code 9 comprises code of an operating system (OS), as well as code of one or more applications configured to run on the operating system. The code 9 includes code 36 of a user interface (UI) layer, depicted in FIG. 2 and denoted by reference numeral 20.

FIG. 2 shows various modules that represent different aspects of the functionality of the code 9. In particular, FIG. 2 shows a schematic function block diagram of the UI layer 20. The UI layer 20 is a computer program that facilitates interactions between a user and a visual interface object 206 (gravity key interface). The UI layer 20 also uses the tracking inputs to detect engagement with the visual interface and provide appropriate selection inputs to at least one application 212. For example, although not shown explicitly, the code 36 of the UI layer 20 may form part of the program code of the OS on which different application may be run. In this case, the UI layer 20 provide a common interface between the user and whatever application(s) might be running on the OS at a particular time.

The UI layer 20 is shown to receive tracking inputs from a user pose tracking module 204. The tracking inputs define a “pointing vector” 205, which is a time-dependent pose vector for tracking particular types of user motion.

The pointing vector 205 tracks a location and orientation associated with a user wearing the device 2. The pointing vector 205 may take the form of a 6D ‘pose vector’ (x,y,z,P,R,Y), where (x,y,z) are the Cartesian coordinates of a particular point of the user with respect to a suitable origin and (P,R,Y) are the pitch, roll and yaw of the user with respect to suitable reference axes.

In the present example, visual interface object 206 takes the form of a 3D virtual keyboard object 206, having a plurality of selectable keys. Each key 208a has an associated selection parameter, in the form of a depth variable 208b, whose current value defines a depth of the key in 3D space, relative to the 3D location (x,y,z) associated with the user.

A rendering module 207 of the device renders a 3D view of the virtual keyboard 206 via the light engines 17, along with any other virtual objects in the environment. The rendered view is updated as the user moves through the environment, as measured through 6D pose tracking of the user's head, in order to mirror the properties of a real-world object. In order to render such a 3D virtual view, the rendering module 206 generates a stereoscopic image pair visible to the user of the device 2, which create the impression of 3D structure when projected onto different eyes.

A user selects a particular key 208a by pointing at that key 208a within the rendered view of the virtual keyboard 206, i.e. causing the pointing vector 205 to intersect a visible area of that key. The visible area is an area it occupies in the stereoscopic image, which the rendering module 207 will determine in dependence on the value of its depth variable 208b in order to create a realistic sense of depth. In the described examples, the pointing vector 205 is a head pose vector for tracking changes in the location and/or orientation of the user's head; in this case, the user selects a particular key 208a by pointing their head towards it. However, in other implementations the pointing vector 205 could, for example, track the user's gaze, or the motion of a particular limb (e.g. arm) or digit (e.g. finger).

Each key 208a is rendered at a depth defined by the value of its depth variable 208b. For as long as the user continues to point at the key 208a, the UI layer 208 incrementally decreases its associated depth variable from its initial value. The user thus perceives the key 208a as moving towards him or her in 3D space. A motion model is used to incrementally decrease the depth in a realistic manner. For example, the depth may be decreased with constant acceleration towards the location of the user. The key 208a is only selected if and when a threshold depth is reached. The motion model is such that it will take longer for a key to reach the threshold depth if the initial depth value is higher (i.e. for keys that start further away from the user).

Whenever a key is selected in this manner, a predictive model 204 of the UI layer 20 is used to re-initialize the depth variable 208b associated with each key 208a. The predictive model 204 estimates, for each key 208a, a probability of the user selecting that key next, based on one or more of the user's previous key selections. Keys that are more likely to be selected next are re-initialized to lower depth values, i.e. closer to the user in 3D space. Because they are closer to the user, they not only occupy a larger visible area (and are therefore easier to select), but they also take less time to select (because they are starting closer to the threshold depth and thus take less time to reach it).

When a key is selected, this triggers a corresponding selection input 210 to the application 212. For example, this could be a character selection input, with different keys corresponding to different text characters to mirror the functionality of a conventional keyboard. In this case, the predictive model 204 could, for example, take the form of a language model providing a “predictive text” function. It will be appreciated that this is merely one example of an action associated with a key that is instigated in response to that key being selected (i.e. in response to its selection criterion being satisfied).

In the context of head and gaze tracking, the pointing vector 205 may be referred to as a line of sight (LOS). The following description considers head tracking by way of example, and uses the LOS terminology. However the description is not limited in this respect, and applies equally to other forms of pointing vector 205 and tracking.

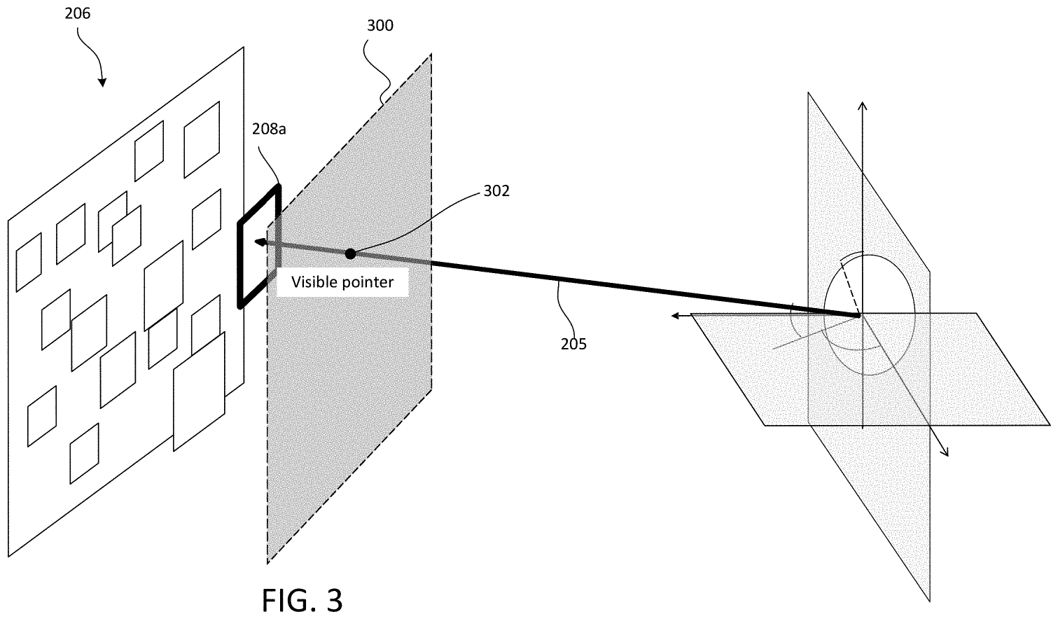

FIG. 3 shows a perspective view of a user interacting with the rendered virtual keyboard 206 via the AR device 2. Relative to the location of the user, the keys of the virtual keyboard are rendered behind, and substantially parallel to, a selection surface 300 defined in 3D space. Different keys of the keyboard each occupy a different (x,y) position, but the position of each key 208a along the z-axis (depth) is dependent on the predicted likelihood of that key being the next key selected by the user.

The selection surface 300 lies between the virtual keyboard 206 and the user, and defines the threshold depth for each key. FIG. 3 shows the LOS 205 intersecting the key denoted by reference numeral 208a. For as long as that intersection condition is satisfied, the key 208a will move towards the selection surface 300. If and when the key 208a reaches the selection surface 300 (the point at which it reaches its threshold depth), that key 208a is selected.

The keyboard 200 and a visible pointer 301 is presented in front of user in the virtual 3D space. The location of the visible pointer 301 is defined by the intersection of the LOS 205 with the selection surface 300.

The keyboard 200 and the pointer 302 are rendered at a fixed distance (depth) relative to the user's location (x,y,z). Although the section surface 300 is depicted as a flat plane, it can have take other forms. For example, the selection surface 300 could take the form of a sphere or section of a sphere with fixed radius, centered on the user's location, such that the pointer 302 is always a fixed distance from the user equal to the radius.

When the user points to a key 208a, he or she perceives the key 208a as moving towards the pointer 301, according to whatever motion model is applied (e.g. with constant acceleration).

When user moves his or her head, the (x,y) position of the pointer 302 tracks the user's head movement, allowing the user to point to different keys of the keyboard 206.

When a character is inputted, the probabilities of all keys being selected as next character are predicted by a pre-trained language model or other suitable predictive model 204. The z-position of each key relative to the user is then updated by its predicted probability.

The pose vector 306 may intersect with a key 302 of the keyboard. If a key 208a is intersected by the pose vector 306, the key 208a may be rendered with a signal to the user that this key is currently intersected. The position of this key 208a may be continuously updated while it is intersected by moving it 208a along the z-axis. If and when the key 208a reaches the selection surface 300, the key 302 is selected, and the keys are subsequently re-rendered at new depths in response to that selection.

The term “pointer” is also used herein to refer to a pointing location or direction defined by the user, and the user pose vector 205 is a pointer in this sense. A pointer in this sense may or may not be visible, i.e. it may or may not be rendered so that it is visible to the user. In a 2D context, a pointer could, for example, be a point or area defined in a 2D display plane. It shall be clear in context which is referred to.

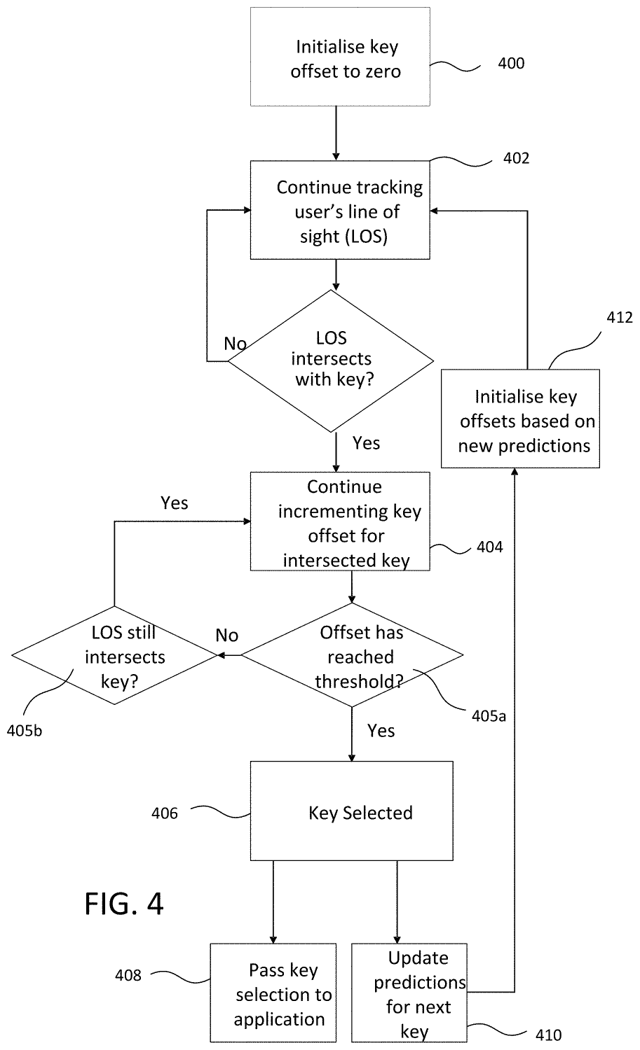

FIG. 4 shows a flowchart for the process for the selection of keys by the user.

At a first step 400, before any keys have been selected by the user, the depth of each key is initialized to some appropriate value, e.g. with all keys at the same predetermined distance behind the selection surface 300, on the basis that all keys are equally likely to be selected first.

The user's line of sight is continuously tracked (402) to identify where the LOS 205 intersects with the keyboard. If the LOS intersects with a key, the process proceeds to step 404, in which the depth of the key start to be incrementally decreased (moving it gradually closer towards the selection surface 300).

At each iteration of step 404, a check (405a) is first done to see if the key has reached the threshold z-value defined by the selection surface 300. If the threshold has been reached, the process moves to step 406. Otherwise, a check (406b) is carried out to determine whether the LOS still intersects with the current key. If so, step 404 continues and the key continues moving along the z-axis until either the selection surface 300 is reached or the user's line of sight 205 moves outside of the visible area of that key.

Steps 404, 405a and 405b constitute a selection routine that is instigated when a user engages with a key (by pointing to it). The selection routine terminates, without selecting the key 208, if the user stops engaging with the key before it reaches the selection surface 300. If the user maintains engagement long enough for the key 208a to reach the selection surface 300, the key is selected (406), and the selection routine terminates. This is the point at which a selection input is provided to the application 212 (408), and the depth values of all keys are re-initialized (412) to take account for that most recent key selection.

In more detail, in step 406, the key that has reached the selection surface 300 is selected and the key is added to the user input passed to the application desired by the user (step 408).

At step 410, the key selection is also passed to the predictive model 204 which calculates new predicted values for each key based on the current selection. In step 410, the key depth values are re-initialised for the next key selection by the rendering module based on the predictions passed to it by the predictive model 204 and the process re-commences at step 402.

Whilst a specific form of AR headset 2 has been described with reference to FIG. 1, this is purely illustrative, and the present techniques can be implemented on any form of computer device with visual display capability. This includes more traditional devices such as smartphones, tablets, desktop or laptop computer and the like. The term tracking inputs is used is a broad sense, and can for example include inputs from a mouse, trackpad, touchscreen and the like. Whilst the above examples consider a 3D interface in a 3D virtual environment, 2D implementations of the gravity key interface are viable. As noted, the modules shown in FIG. 2 are functional components, representing, at a high level, different aspects of the code 9 depicted in FIG. 1. Likewise, the steps depicted in FIG. 4 are computer-implemented. In the above examples, the selection duration is defined indirectly by the initial depth of the key, in combination with the applied motion model. However, in other implementations, the selection duration could be defined in other ways, e.g. directly in units of time. In general a computer system can take the form of one or more computers, programmed or otherwise configured to carry out the operations in question. A computer may comprise one or more hardware computer processors and it will be understood that any processor referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware). Reference is made herein to data storage for storing data, such as memory or computer-readable storage device(s). This/these may be provided by a single device or by plural devices. Suitable devices include for example a hard disk and non-volatile semiconductor memory (e.g. a solid-state drive or SSD). Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

A first aspect herein provides a computer-implemented method of processing tracking inputs for engaging with a visual interface having selectable visual elements, the method comprising: receiving the tracking inputs, the tracking inputs for tracking user motion; processing the tracking inputs and, in response to the tracking inputs satisfying an engagement condition of any of the visual elements, instigating a selection routine for the visual element based on at least one selection parameter of the visual element. If the engagement condition remains satisfied until a selection criterion of the selection routine is met, an action associated with the visual element is instigated. If the engagement condition stops being satisfied before the selection criterion is met, the selection routine terminates without selecting the visual element; and wherein each time any of the visual elements is selected, a predictive model is used to update the at least one selection parameter of at least one other of the visual elements, thereby modifying a duration for which the engagement condition must be satisfied before the selection criterion is met according to a likelihood of the other visual element being subsequently selected.

In embodiments, the visual interface may be defined in 2D or 3D space.

In 3D space, the tracking inputs may be for tracking user pose changes.

In 3D space, the at least one selection parameter of each visual element may set an initial depth of the visual element in 3D space. The selection routine may apply incremental depth changes to any of the visual elements whilst the engagement condition of that visual element is satisfied, the selection criterion being met if and when that visual element reaches a threshold depth. The predictive model may be used to modify the initial depth of the other visual element, thereby modifying the duration for which the engagement condition must be satisfied in order for the other visual element to reach the threshold depth.

The selection routine may apply the incremental depth changes according to a motion model (e.g. a constant acceleration model).

The engagement condition of each visual element may be that a user pose vector (or more generally a pointer in 2D or 3D space) intersects a visible area of the visual element. If the pose vector (or pointer) remains intersected with the visible area of any of the visual elements until the selection criterion is met, the visual element may be selected. If the pose vector (or pointer) stops intersecting the visible area of the visual element before the selection criterion is met, the selection routine may terminate without selecting the visual element.

The user pose vector may define one of: a head pose vector, an eye pose vector, a limb pose vector, and a digit pose vector.

The at least one selection parameter of each visual element may define a visible area of the visual element (e.g. the above visible area), and the updated selection parameter may increase the visible area of the other visual element if it is more likely to be subsequently selected.

In a 3D implementation, the visible area may be defined by the depth of the visual element, in 3D space, relative to a user location. The initial depth of the other visual element relative to the user location may be reduced if it is more likely to be subsequently selected, thereby both increasing its visible area and reducing the duration for which the engagement condition must be satisfied.

If the selection routine terminates at a terminating depth, before the threshold depth is reached, because the engagement condition is no longer satisfied, and the engagement condition for the same visual element becomes satisfied again before any other visual element is selected, the selection routine may resume from the terminating depth for that visual element. For example, in the above depth-based implementation, the visual element may stop at its current depth when the user stops engaging with it (rather than returning to its initial depth). Alternatively, the selectable element may return to its initial depth.

Said action associated with the visual element may comprise providing an associated selection input to an application. For example, the selection input may be a character selection input and the predictive model comprises a language model for predicting the likelihood of one or more subsequent character selection inputs.

A virtual or augmented reality view of the visual interface may be rendered using one or more light engines, and updated based on the tracking inputs.

A second aspect herein provides a computer system comprising: a user interface configured to generate tracking inputs for tracking user motion and render a visual interface having selectable elements; one or more computer processors programmed to apply the method of the first aspect or any embodiment thereof to the generated tracking inputs for engaging with the rendered visual interface.

In embodiments, the one or more computer processors may be programmed to carry out the method of claim. The user interface may comprise one or more sensors configured to generate the tracking inputs, and one or more light engines configured to render the virtual or augmented reality view of the visual interface.

A third aspect herein provided non-transitory computer readable media embodying program instructions, the program instructions configured, when executed on one or more computer processors, to carry out the method of the first aspect or any embodiment thereof.

It will be appreciated that the forgoing description is merely illustrative. Variations and alternatives to the example embodiments described hereinabove will no doubt be apparent to the skilled person. The scope of the present disclosure is not defined by the described examples by only by the accompanying claims.

1. A computer-implemented method of processing tracking inputs for engaging with a visual interface having selectable visual elements, the method comprising:
receiving the tracking inputs for tracking user motion;
determining that the tracking inputs satisfy an engagement condition of a selectable visual element from the selectable visual elements;
instigating a selection routine for the selectable visual element based on at least one selection parameter of the selectable visual element;
determining that the engagement condition remains satisfied until a selection criterion of the selection routine is met;
based at least on determining that the engagement condition remains satisfied until a selection criterion of the selection routine is met, identifying the selectable visual element as being selected;
upon the selectable visual element being selected, instigating an action associated with the selectable visual element; and
update one or more selection parameters of at least one other of the selectable visual elements by modifying a duration for which an engagement condition must be satisfied before a selection criterion is met based at least on a likelihood of the at least one other of the selectable visual elements being subsequently selected.

2. The method of claim 1, wherein the visual interface is defined in 3D space, and the tracking inputs are for tracking user pose changes.

3. The method of claim 2, wherein a virtual or augmented reality view of the visual interface is rendered using one or more light engines, and updated based on the tracking inputs.

4. The method of claim 2, wherein the at least one selection parameter of the selectable visual element sets an initial depth of the selectable visual element in 3D space;
wherein the selection routine decreases a depth to the selectable visible element whilst the engagement condition of the selectable visual element is satisfied, the selection criterion being met if and when the selectable visual element reaches a threshold depth; and
wherein a predictive model is used to modify an initial depth of the at least one other of the selectable visual elements, thereby modifying the duration for which the engagement condition must be satisfied in order for the at least one other of the selectable visual elements to reach the threshold depth.

5. The method of claim 4, wherein the selection routine applies the incremental depth changes according to a motion model, the motion model and an initial depth defining a duration for which an engagement condition must be satisfied.

6. The method of claim 4, wherein if the selection routine terminates at a terminating depth, before the threshold depth is reached, because the engagement condition is no longer satisfied, and the engagement condition for a same selectable visual element becomes satisfied again before any other of the selectable visual elements is selected, the selection routine resumes from the terminating depth for that selectable visual element.

7. The method of claim 1, wherein the engagement condition of the selectable visual element is that a pointer defined by the tracking inputs intersects a visible area of the selectable visual element;
wherein if the pointer remains intersected with the visible area of the selectable visual element until the selection criterion is met, the selectable visual element is selected;
wherein if the pointer stops intersecting the visible area of the selectable visual element before the selection criterion is met, the selection routine terminates without selecting the selectable visual element.

8. The method of claim 7, wherein the visual interface is defined in 3D space, and the tracking inputs are for tracking user pose changes, the pointer being a user pose vector.

9. The method of claim 8, wherein the user pose vector defines one of: a head pose vector, an eye pose vector, a limb pose vector, and a digit pose vector.

10. The method of claim 1, wherein the at least one selection parameter of the selectable visual element defines a visible area of the selectable visual element, and the updated selection parameter increases the visible area of the at least one other of the selectable visual elements if it is more likely to be subsequently selected.

11. The method of claim 10, wherein the visual interface is defined in 3D space, the tracking inputs are for tracking user pose changes, and the at least one selection parameter of the selectable visual element sets an initial depth of the selectable visual element in 3D space;
wherein the selection routine applies incremental depth changes to any of the selectable visual elements whilst the engagement condition of the selectable visual element is satisfied, the selection criterion being met if and when the selectable visual element reaches a threshold depth; and
wherein the predictive model is used to modify an initial depth of the at least one other of the selectable visual elements, thereby modifying the duration for which the engagement condition must be satisfied in order for the at least one other of the selectable visual elements to reach the threshold depth; and
wherein the visible area is defined by the depth of the selectable visual element, in 3D space, relative to a user location, wherein the initial depth of the at least one other of the selectable visual elements relative to the user location is reduced if it is more likely to be subsequently selected, thereby both increasing its visible area and reducing the duration for which the engagement condition must be satisfied.

12. The method of claim 1, wherein the action associated with the selectable visual element comprises providing an associated selection input to an application.

13. The method of claim 12, wherein the selection input is a character selection input and a predictive model predicts a likelihood of one or more subsequent character selection inputs.

14. A computer system comprising:
a user interface configured to generate tracking inputs for tracking user motion and render a visual interface having selectable visual elements;
one or more computer processors configured to:
determining the tracking inputs satisfy an engagement condition of a selectable visual element from the selectable visual elements;
instigating a selection routine for the selectable visual element based on at least one selection parameter of the selectable visual element;
determining that the engagement condition remains satisfied until a selection criterion of the selection routine is met;
based at least on determining that the engagement condition remains satisfied until a selection criterion of the selection routine is met, identifying the selectable visual element as being selected;
upon the selectable visual element being selected, instigating an action associated with the selectable visual element;
update one or more selection parameters of at least one other of the selectable visual elements by modifying a duration for which an engagement condition must be satisfied before a selection criterion is met based at least on a likelihood of the at least one other of the selectable visual elements being subsequently selected.

15. The computer system of claim 14, wherein the user interface comprises one or more sensors configured to generate the tracking inputs, and one or more light engines configured to render a virtual or augmented reality view of the visual interface.

16. The computer system of claim 14, wherein the engagement condition of the selectable visual element is that a pointer defined by the tracking inputs intersects a visible area of the selectable visual element;
wherein if the pointer remains intersected with the visible area of any of the selectable visual elements until the selection criterion is met, the selectable visual element is selected;
wherein if pointer stops intersecting the visible area of the selectable visual element before the selection criterion is met, the selection routine terminates without selecting the selectable visual element.

17. Non-transitory computer readable media embodying program instructions, the program instructions configured, when executed on one or more computer processors, to:
cause a user interface to render a visual interface having selectable visual elements;
determine that the tracking inputs satisfy an engagement condition of a selectable visual element from the selectable visual elements;
instigate a selection routine for the selectable visual element based on at least one selection parameter of the selectable visual element;
determine that the engagement condition remains satisfied until a selection criterion of the selection routine is met;
based at least on determining that the engagement condition remains satisfied until a selection criterion of the selection routine is met, identify the selectable visual element as being selected;
upon the selectable visual element being selected, instigate an action associated with the selectable visual element;
update one or more selection parameters of at least one other of the selectable visual elements by modifying a duration for which an engagement condition must be satisfied before a selection criterion is met based at least on a likelihood of the at least one other of the selectable visual elements being subsequently selected.

18. The non-transitory computer readable media of claim 17, wherein the visual interface is defined in 3D space, and the tracking inputs are for tracking user pose changes.

19. The non-transitory computer readable media of claim 18, wherein the at least one selection parameter of the selectable visual element sets an initial depth of the visual element in 3D space;
wherein the selection routine is configured to apply incremental depth changes to any of the selectable visual elements whilst the engagement condition of the selectable visual element is satisfied, the selection criterion being met if and when the selectable visual element reaches a threshold depth; and
wherein the one or more processors are configured to use a predictive model to modify an initial depth of the at least one other of the selectable visual elements, thereby modifying a duration for which the engagement condition must be satisfied in order for the at least one other of the selectable visual elements to reach the threshold depth.

20. The non-transitory computer readable media of claim 19, wherein the selection routine is configured to apply the incremental depth changes according to a motion model, the motion model and an initial depth defining a duration for which an engagement condition must be satisfied.
